(19) United States
(12) Patent Application Publication
(10) Pub. No.: US 2009/0110914 A1
(43) Pub. Date: Apr. 30, 2009

(54) Process for Producing Hurricane-Resistant Glass

(76) Inventors: Dajian Zhuang, Guangdong (CN); Suxi Qiu, Guangdong (CN)

Correspondence Address: HARNESS, DICKEY & PIERCE, P.L.C., P.O. BOX 828, BLOOMFIELD HILLS, MI, 48303, US

(21) Appl. No.: 11/922,861

(22) PCT Filed: Dec. 11, 2006
(86) PCT No.: PCT/CN2006/003364

§ 371 Date: Dec. 26, 2007

(30) Foreign Application Priority Data
Dec. 28, 2005 (CN) 200510121498.8

(51) Int. Cl. B32B 17/06; C03C 17/30; B32B 27/06; C03C 14/00

(52) U.S. Cl. 428/335; 65/31; 501/32; 428/429; 428/426

(57) ABSTRACT

A method for producing hurricane-resistant glass, mainly includes the steps of: cutting and abrading the edges of a glass; feeding the glass into a tempering furnace and heating the glass to a critical state of the softening point; feeding the glass heated to a critical state of the softening point at a speed of 25-50 cm/s into a cooling chamber, to allow the glass to develop a surface compressive stress of not less than 150 MPa; etching the cooled glass with an etching solution; and rinsing surfaces of the glass. The invention further relates to the hurricane-resistant glass produced thereby and glass assemblies containing the said hurricane-resistant glass.

### CROSS-REFERENCE TO RELATED APPLICATIONS

This application is a 371 National Stage of International application No. PCT/CN2006/003364, filed Dec. 11, 2006. This application claims the benefit of CN 200510121498.8, filed Dec. 28, 2005. The disclosures of the above applications are incorporated herein by reference.

### FIELD OF THE INVENTION

The invention relates generally to a method for producing glass, and more particularly to a method for producing hurricane-resistant glass and the hurricane-resistant glass produced thereby.

### BACKGROUND OF THE INVENTION

In recent years, with the global environmental deterioration, human beings are more and more frequently attacked by hurricanes, and more and more buildings need to be mounted with hurricane-resistant glass, therefore there is a great need for processes for producing hurricane-resistant glass in bulk at a low cost.

Theoretically, increasing the surface stress of glass can improve its strength. However, some defects, for example microcracks, inevitably exist on the surface of glass. Therefore, if the surface stress of glass is improved excessively, the glass tends to break spontaneously at defect locations because of stress concentration or will be caused to break by slight impacts from the surroundings, or is damaged by the developing of microcracks due to combined action of the inner stress at the defected locations and cyclic dynamic loadings from the surroundings, such as wind load. As a result, hurricane-resistant glass can not be obtained only by increasing the surface stress of glass.

Defects on the surface of glass can be eliminated by etching the surface of glass using chemical solutions, but improper control of the etching process will greatly reduce the surface compressive stress of the glass while eliminating the defects. Particularly, as for reinforced glass produced by a chemical strengthening process alone, it is not easy or suitable to use a chemical solution to eliminate the defects on the surface of the glass because of its thin stress layer.

The chemical strengthening technology can be used to effectively improve the surface stress of glass, however, the exclusive use of chemical strengthening technology will result in high production cost and long production time. Furthermore, merely a small amount of special glass can be produced by the chemical strengthening method. So this method is not suitable for large-scale production in industry to meet the great demands of buildings.

In conclusion, in terms of inherent properties, the ability of glass for resisting breaking mainly depends on the comprehensive balance and mutual restraint of multiple factors including the magnitude of the surface stress, the thickness of the stress layer, and the degree of the elimination of surface defects. In terms of external performances, the ability of glass for resisting the impacting of hurricanes is determined by the overall effects of multiple properties, including relatively high stability (the ability of keeping from spontaneous breaking or being caused to break) and tenacity (the ability of keeping intact after the impacting of multiple vibration loads) besides relatively high compression strength, counter bending strength and shock strength. Only when the above factors are all satisfied, is it possible to produce glass with high breaking resistance. These factors, as well as the mutual restraint and even mutual contradiction therebetween, have hampered people's endeavor to improve the breaking resistance of glass. Theoretically the strength of glass can be as high as 10,000-20,000 MPa, but the actual breakage resistance of the produced glass is less than 1% of the theoretical value. Therefore, it remains a practical rather than a purely theoretical problem how to produce glass with better hurricane-resistant performance, and the person skilled in the art of glass keeps trying to solve this problem.

In recent years, in countries where hurricanes frequently happen, for example USA, many efforts have been made to improve the hurricane-resistant performances of glass. The ASTM in the US has set up a test criteria for hurricane-resistant glass assembly (ASTM designation: E 1996-04 and E 1886-04): firstly, no break should be generated after glass is impacted by wood blocks or steel ball with a certain weight at a certain speed; secondly, the impacted glass assembly should not generate penetrating breaks after being subjected to positive/negative cyclic air pressure for 9,000 times. The glass meeting the above test criteria can be called hurricane-resistant glass.

In the prior art, the glass manufacturers throughout the world have to adopt laminated hurricane-resistant glass assembly sandwiched with thicker PVB sheets or plastics in order to pass the tests according to the above US criteria. For example, a hurricane-resistant glass assembly structure was disclosed in Chinese Patent No. CN9718980.1 granted to the Solutia Company in US. However, the disclosed glass assembly structure has obvious shortcomings: firstly, the PVB sheets or plastics sandwiched within the glass will be rapidly aged after being used for a period of time, resulting in the reduction of the hurricane-resistant performance of the glass assembly; secondly, although it is possible for the glass assembly to pass the test, the overall glass assembly can but pass a test criteria of relatively low grade due to the low strength of single glass panel.

In other words, all the hurricane-resistant glass assemblies that have passed the ASTM test criteria are laminated glass structures, and none of the manufacturers has developed a process to produce single glass panel with hurricane-resistant performance, neither single glass sheet will meet the US criteria above.

### DISCLOSURE OF THE INVENTION

The objective of the present invention is to provide a method for producing hurricane-resistant single glass sheets, which have the advantages of low cost and time saving.

To achieve these objects, the inventive method mainly comprises the steps of: (a) cutting and abrading the edges of a glass; (b) feeding the glass into a tempering furnace and heating the glass to the critical state at the soften point; (c) feeding the glass heated to the critical state at the soften point at a speed of 25-50 cm/s into a cooling chamber with a wind pressure controlled within the range of from 6.5 to 7.5×10³ Pa, to allow the glass to develop a surface compressive stress of no less than 150 MPa; (d) etching the cooled glass with an acidic solution comprising, based on the total weight of the acidic etching solution, 1 to 10 wt % of HF, 25 to 65 wt % of H₂SO₄ and water at a temperature of from 15 to 40° C. for a period of 15-30 minutes; and (e) rinsing the surfaces of the glass.

In a preferred embodiment of the invention, the acidic solution comprises, based on the total weight of the acidic etching solution, 5-10 wt % of HF, preferably 5-8 wt %; 30-60 wt % of H₂SO₄, preferably 30-50 wt %; and water. The acidic solution is performed at 20-40° C., preferably 30-40° C., for 20-30 min, preferably 20-25 min.

According to another preferred embodiment of the invention, in step (b) of the process, Cs and K salts solution is sprayed onto the surface of glass while the glass is being heated, wherein the Cs and K salts solution comprises, based on the total weight of the Cs and K salts solution, 35-65 wt % of a potassium salt, 1-6 wt % of a sodium salt, 0.5-1.5 wt % of a cesium salt, 0.2-10 wt % of a tackifier, 2-20 wt % of tin compound remover, 0.2-1.2 wt % of surfactant, and water.

More preferably, the Cs and K salts solution comprises, based on the total weight of the Cs and K salts solution, 40-60 wt % of potassium salt, 1-5 wt % of sodium salt, 1-1.5 wt % of cesium salt, 5-10 wt % of a tackifier, 5-15 wt % of a tin compounds remover, 0.5-1.2 wt % of a surfactant, and water.

In the Cs-K salt solution, the potassium salt can be any one of inorganic potassium salts, preferably selected from the group consisting of potassium sulphate, potassium nitrate, potassium chloride and potassium phosphate; the sodium salt can be any inorganic sodium salt, preferably selected from the group consisting of sodium phosphate, sodium hydrogen phosphate, sodium sulphate, sodium nitrate, and sodium chloride; the cesium salt can be any inorganic cesium salt, preferably selected from the group consisting of cesium sulphate, cesium nitrate, cesium chloride and cesium phosphate; the tackifier is preferably starch; and the tin compound remover is preferably SnCl₄.

In another preferred embodiment of the invention, after the step (e), an additional step of spraying protective film of organosilicon onto the surface of glass is carried out. The protective film of organosilicon can be selected from diethyldichlorosilane, phenyl trichlorosilane, MY-4K varnish and silicone oil. The protective film of organosilicon can be formed by electrostatic spraying, jetting, or manual coating, followed by curing. The thickness of the protective film of organosilicon can be 15-50 μm, preferably 20-40 μm.

In yet another preferred embodiment of the invention, water or alkaline solution such as an aqueous solution of sodium carbonate or sodium bicarbonate is used for rinsing the glass before the acidic etching in step (d).

The invention also provides single sheets of hurricane-resistant glass produced by the above described method.

The invention further provides a glass assembly comprising the hurricane-resistant glass sheets produced in accordance with the invention. The glass assembly is preferably a laminated glass structure, wherein polymer sheets such as sheets of PVB, polycarbonate, polyurethane, and PVC are sandwiched between the sheets of hurricane-resistant glass according to the present invention.

Without bound to any existing theories, the applicant believes that in the glass production process of the invention, a proper acidic etching step can blunt the microcracks on the surface of the glass, and thus essentially eliminating the defect surface layer on the glass. On the other hand, in terms of the thickness of the stress layer produced in the chemical strengthening step, the acidic etching step can avoid overetching and prevent the stress layer from damage.

Compared to the glass products and the manufacture processes therefore in the prior art, the glass manufacture process according to the present invention facilitates the balance among the elimination of surface defects, surface compressive stress and the thickness of the surface stress layer, and avoids improving one of these performances while ignoring others. Therefore, the single glass sheets produced have hurricane-resistant property, and can pass the US hurricane-resistant performance tests in a standardized grade higher than that of the hurricane-resistant glass assembly produced by conventional laminated glass.

In addition, the glass manufacture process of the present invention has the advantages of shorter production time and lower cost as compared to the conventional processes using chemical strengthening alone, and thus is suitable for the industrial production of glass at a batch and large scale. When physically strengthening glass by heating in a toughening furnace, a Cs-K salt solution can be sprayed onto the surface of glass to assist in the chemical strengthening, so as to further improve the surface compressive stress of the glass.

Spraying of an organosilicon protective film onto the surface of glass can prevent the formation of new microcracks during the use of the glass, thereby further improve the ability of the glass in resisting damage.

In fact, the single glass sheets as produced in the present invention can not only be used as hurricane-resistant glass alone, but also be combined with other glasses to form hurricane-resistant glass assembly with a laminated configuration.

### DETAILED DESCRIPTION OF THE INVENTION

### EXAMPLE 1

The process for producing hurricane-resistant glass of the present invention mainly comprised the following steps: (a) cutting an ordinary glass with a thickness of 19 mm into a size of 1524×2440 mm, and finely abrading the edges of the glass; (b) feeding the glass into a toughening furnace and heating it to the critical state at the softening point while spraying a Cs-K salt solution onto the surfaces of the glass, wherein the Cs-K salt solution comprises (by weight): potassium salt (K₂SO₄ and KNO₃ at a weight ratio of 3:1) 36%, sodium salt (Na₃PO₄) 1%, cesium salt (CsNO₃) 0.5%, tackifier (starch) 10%, tin-compound remover (SnCl₄) 20%, a surfactant (sodium dodecanesulphonate, ROSO₃Na) 0.2% and water 32.3%; (c) feeding the glass at a speed of 25 cm/s into a cooling chamber with an air pressure controlled at 7.2×10³ Pa, to allow the glass to develop a surface compressive stress of 180 MPa; (d) rinsing the toughened glass with water, and etching it in a bath with an acidic solution comprising 3 wt % of HF, 65 wt % of H₂SO₄ and water at 40° C. for 30 min; (e) rinsing the surfaces of the glass with water, and air drying; and (f) electrostatically spraying a protective film of diethyldichlorosilane with a thickness of 50 μm on the surfaces of the glass, and oven drying it to obtain a hurricane-resistant glass.

The obtained single glass sheets were tested according to the ASTM E 1996 test criteria. The glass sheets were each impacted once respectively on the edges and in the middle part with a wood block with a length of 2.4 m and a weight of 4,100 g at a speed of 15.2 m/s. The glass sheets remained intact. Then the glass sheets were subjected to a cyclic loading test at an air pressure of ±150 PSF(7182 Pa) for 9,000 times. The glass sheets remained intact.

In a comparative experiment, ordinary glass sheets with the same thickness and the same size as the aforementioned hurricane-resistant glass were processed according to the procedure of Example 1 except that steps (d), (e), and (f) were omitted, resulting in a control group of toughened glasses. The control glasses were tested in accordance with ASTM E 1996 test criteria as mentioned above, and the results indicated that the control group of toughened glass was broken after being impacted only once, apparently not meeting the requirements of the ASTM E1996. Therefore, a proper acidic etching treatment was obviously necessary for the process of the present invention.

### EXAMPLE 2

The process for producing the hurricane-resistant glass of the present invention mainly comprised the following steps: (a) cutting an ordinary glass with a thickness of 15 mm into a size of 2774×1414 mm, and finely abrading the edges of the glass; (b) feeding the glass into a toughening furnace and heating it to the critical state at the softening point while spraying a Cs-K salt solution onto the surfaces of the glass, wherein the Cs-K salt solution comprises (by weight): potassium salt 60%, sodium salt 5%, cesium salt 1.5%, tackifier 1%, tin-compound remover 3%, a surfactant 1% and water 28.5%; (c) feeding the glass at a speed of 30 cm/s into a cooling chamber with an air pressure controlled at 7.0×10³ Pa, to allow the glass to develop a surface compressive stress of 170 MPa; (d) rinsing the toughened glass with 20 wt % aqueous Na₂CO₃ solution, and etching it in a bath with an acidic solution comprising 5 wt % of HF, 50 wt % of H₂SO₄ and water at 30° C. for 25 min; (e) rinsing the surfaces of the glass with water, and air drying; and (f) electrostatically spraying a protective film of phenyl trichlorosilane with a thickness of 35 μm onto the surfaces of the glass and oven drying it to obtain a hurricane-resistant glass.

The obtained single glass sheets were tested according to the ASTM E 1996 test criteria. The glass sheets were each impacted once on the edges and in the middle part with a wood block with a length of 2.4 m and a weight of 4,100 g at a speed of 15.2 m/s respectively. The glass sheets remained intact. Then the glass sheets were subjected to a cyclic loading test at an air pressure of ±150 PSF(7182 Pa) for 9,000 times. The glass sheets still remained intact.

In a comparative experiment, ordinary glass sheets with the same thickness and size as the aforementioned hurricane-resistant glass were processed according to the above procedure except for step (d), wherein the acidic etching was performed with an acidic etching solution of 25 wt % aqueous HF solution at 60° C. for 60 min. The control glass sheets were tested in accordance with ASTM E 1996 test criteria as mentioned above, and the results indicated that the control group of toughened glass was broken after being impacted only once, apparently not meeting the requirements of the ASTM E1996. Therefore, an improperly excessive acidic etching treatment could theoretically eliminate the surfacial defects of the glass, but it destroyed the surface stress layer of the glass at the same time.

### EXAMPLE 3

The process for producing hurricane-resistant glass of the present invention mainly comprised the following steps: (a) cutting an ordinary glass with a thickness of 10 mm into a size of 1524×2440 mm, and finely abrading the edges of the glass; (b) feeding the glass into a toughening furnace and heating it to the critical state at the softening point; (c) feeding the glass at a speed of 40 cm/s into a cooling chamber with an air pressure controlled at 6.8×10³ Pa, to allow the glass to develop a surface compressive stress of 160 MPa; (d) rinsing the toughened glass with water, and etching it in a bath with an acidic solution comprising 6 wt % of HF, 35 wt % of H₂SO₄ and water at 20° C. for 20 min; (e) rinsing the surfaces of the glass with water, and air drying; and (f) electrostatically spraying a protective film of MY-4K varnish (brand “Bende”, purchased from Qingyuan Tongchang Painting Limited Company, Guangdong Province, China) with a thickness of 20 μm onto the surfaces of the glass and oven drying it to obtain a hurricane-resistant glass. The obtained single glass sheets were tested according to the ASTM E 1996 test criteria. The glass sheets produced according to the above procedure were impacted respectively on the edges and in the middle part with a wood block with a length of 2.4 m and a weight of 4,100 g at a speed of 15.2 m/s, each for one time. The glass sheets remained intact. Then the glass sheets were subjected to a cyclic loading test at an air pressure of ±150 PSF(7182 Pa) for 9,000 times. The glass sheets remained intact.

In a comparative experiment, ordinary glass sheets with the same thickness and the same size as the aforementioned hurricane-resistant glass were processed according to the above procedure (steps (a), (b), (e), and (f)) except for step (c) wherein the air pressure in the cooling chamber was controlled at 8.0×10³ Pa and step (d) wherein the acidic etching was performed at 5° C. for 3 min, resulting in a control of toughened glass. Then the control group of toughened glass was subjected to the same test, and the test results indicated that the control glass was broken upon being impacted only once, apparently not meeting the requirements of the ASTM E1996. Therefore, the increasing of the air pressure in the cooling chamber could theoretically improve the inner stress of the glass surface, however, because of the incomplete elimination of the surfacial microcracks of the glass due to deficient acid etching treatment, the microcracks with large focused inner stress would greatly reduce the overall damage resistance ability of the glass.

### EXAMPLE 4

The process for producing the hurricane-resistant glass mainly comprised the following steps: (a) cutting ordinary glass sheets with a thickness of 8 mm into a size of 1524×2440 mm, and finely abrading the edges of the glass; (b) feeding the glass into a toughening furnace and heating it to the critical state at the softening point; (c) feeding the glass at a speed of 50 cm/s into a cooling chamber with an air pressure controlled at 6.5×10³ Pa, to allow the glass to develop a surface compressive stress of 152 MPa; (d) rinsing the toughened glass with 20 wt % of aqueous Na₂CO₃ solution, and then etching it in a bath with an acidic solution comprising 1 wt % of HF, 25 wt % of H₂SO₄ and water at 15° C. for 15 min; (e) rinsing the surfaces of the glass with water, and air drying; and (f) spraying a protective film of silicone oil with a thickness of 15 μm by manually coating onto the surfaces of the glass, and finally oven drying it to obtain a hurricane-resistant glass.

The obtained single glass sheets were tested according to the ASTM E 1996 test criteria. The glass sheets were impacted respectively on the edges and in the middle part with a wood block with a length of 2.4 m and a weight of 4,100 g at a speed of 15.2 m/s, each for one time. The glass sheets remained intact. Then the glass sheets were subjected to a cyclic loading test at an air pressure of ±150 PSF (7182 Pa) for 9,000 times. The glass sheets still remained intact.

In a comparative experiment, ordinary glass sheets with the same thickness and the same size as the aforementioned hurricane-resistant glass were processed according to the above procedure, wherein steps (a) and (b) were the same as the above, yet in step (c), the air pressure in the cooling chamber was controlled at 8.1×10³ Pa, and steps (d), (e), and (f) were omitted. A control group of toughening glass was obtained. Then the control glass was subjected to a cyclic loading test at an air pressure of ±150 PSF (7182Pa). The results showed that the glass tended to break before the cyclic loadings reached 9,000 times. Therefore, although the increasing of the air pressure in the cooling chamber could theoretically improve the inner stress of the glass surface, however, due to the absence of acidic etching treatment and spraying of a protective film, the microcracks in the glass gradually enlarged and extended during the cyclic loading test, eventually leading to the breakage of the glass. Therefore, a proper acidic etching treatment was quite necessary for the process of the present invention, and the spraying of a protective film on the glass surface had good effects in improving the tenacity and breaking resistance of the glass.

### EXAMPLE 5

In this example, the hurricane-resistant glass was produced by a process which was essentially the same as example 2, except that in the step (b) the Cs-K salt solution comprised (by weight): potassium salt 39%, sodium salt 3%, cesium salt 1.0%, tackifier 0.5%, tin-compound remover 10%, surfactant 1.2% and water 45.3%.

The obtained single glass sheets were tested according to the ASTM E 1996 test criteria. The glass sheets were impacted respectively on the edges and in the middle part with a wood block with a length of 2.4 m and a weight of 4,100 g at a speed of 15.2 m/s, each for one time. The glass sheets remained intact. Then the glass sheets were subjected to a cyclic loading test at an air pressure of ±150 PSF (7182 Pa) for 9,000 times. The glass sheets still remained intact.

What is claimed is:

1. A method for producing a hurricane-resistant glass, mainly comprising the following steps of:
(a) cutting and abrading the edges of a glass;
(b) feeding the glass into a tempering furnace and heating the glass to the critical state at the softening point;
(c) feeding the glass heated to the critical state at the softening point at a speed of 25-50 cm/s into a cooling chamber with an air pressure controlled within a range of from 6.5 to 7.5×10³ Pa, to allow the glass to develop a surface compressive stress of no less than 150 MPa;
(d) etching the cooled glass with an acidic etching solution comprising, based on the total weight of the etching solution, 1-10 wt % of HF, 25-65 wt % of H₂SO₄ and water, at a temperature of from 15 to 40° C. for 15-30 min; and
(e) rinsing the surfaces of the glass.

2. The method according to claim 1, wherein in step (b), a Cs-K salt solution comprising, based on the total weight of the Cs-K salt solution, 35-65 wt % of potassium salt, 1-6 wt % of sodium salt, 0.5-1.5 wt % of cesium salt, 0.2-10 wt % of tackifier, 2-20 wt % of tin-compound remover, 0.2-1.2 wt % of a surfactant, and water, is sprayed onto the surface of the glass while heating the glass.

3. The method according to claim 1, further comprising a step of spraying a protective film of organosilicon onto the surface of glass after step (e).

4. The method according to claim 3 wherein the protective film of organosilicon is selected from diethyldichlorosilane, phenyl trichlorosilane, MY-4K varnish and silicone oil.

5. The method according to claim 3 wherein the thickness of the protective film of organosilicon is in the range of 15-50 μm.

6. The method according to claim 1 wherein the acidic etching solution comprises 5-10 wt % HF, 30-50 wt % H₂SO₄, and water.

7. The method according to claim 1 wherein the acidic etching is performed at 20-40° C. for 20-30 min.

8. (canceled)

9. The method according to claim 1 wherein in step (d), the glass is rinsed with water or an aqueous alkaline solution prior to acidic etching.

10. A hurricane-resistant glass produced by the method according to claim 1.

11. The hurricane-resistant glass according to claim 10 wherein the glass is in the form of single sheets.

12. The hurricane-resistant glass according to claim 10, wherein in step (b), a Cs-K salt solution comprising, based on the total weight of the Cs-K salt solution, 35-65 wt % of potassium salt, 1-6 wt % of sodium salt, 0.5-1.5 wt % of cesium salt, 0.2-10 wt % of tackifier, 2-20 wt % of tin-compound remover, 0.2-1.2 wt % of a surfactant, and water, is sprayed onto the surface of the glass while heating the glass.

13. The hurricane-resistant glass according to claim 10, further comprising a protective film of organosilicon on the surface of glass.

14. The hurricane-resistant glass according to claim 10, wherein the protective film of organosilicon is selected from diethyldichlorosilane, phenyl trichlorosilane, MY-4K varnish and silicone oil.

15. The hurricane-resistant glass according to claim 10, wherein the thickness of the protective film of organosilicon is in the range of 15-50 μm.

16. The hurricane-resistant glass according to claim 10, wherein the acidic etching solution comprises 5-10 wt % HF, 30-50 wt % H₂SO₄, and water.

17. The hurricane-resistant glass according to claim 10, wherein in the method according to claim 1, the acidic etching is performed at 20-40° C. for 20-30 min.

18. A glass assembly comprising the hurricane-resistant glass according to claim 10.

19. The glass assembly according to claim 18 wherein the glass assembly has the configuration of laminated glass.

20. The glass assembly according to claim 18 wherein the configuration of laminated glass comprises polymer sheets sandwiched between the glass sheets.

21. The glass assembly according to claim 18, wherein in step (b), a Cs-K salt solution comprising, based on the total weight of the Cs-K salt solution, 35-65 wt % of potassium salt, 1-6 wt % of sodium salt, 0.5-1.5 wt % of cesium salt, 0.2-10 wt % of tackifier, 2-20 wt % of tin-compound remover, 0.2-1.2 wt % of a surfactant, and water, is sprayed onto the surface of the glass while heating the glass.

22. The glass assembly according to claim 18, further comprising a protective film of organosilicon on the surface of glass.

23. The glass assembly according to claim 18, wherein the protective film of organosilicon is selected from diethyldichlorosilane, phenyl trichlorosilane, MY-4K varnish and silicone oil.

24. The glass assembly according to claim 18, wherein the thickness of the protective film of organosilicon is in the range of 15-50 μm.

25. The glass assembly according to claim 18, wherein the acidic etching solution comprises 5-10 wt % HF, 30-50 wt % H₂SO₄, and water.

26. The glass assembly according to claim 18, wherein the acidic etching is performed at 20-40° C. for 20-30 min.
